(19) United States
(12) Patent Application Publication
(10) Pub. No.: US 2019/0096195 A1
(43) Pub. Date: Mar. 28, 2019

(54) INFORMATION PROCESSOR AND GAME CONTROL METHOD

(71) Applicant: Universal Entertainment Corporation, Tokyo (JP)

(72) Inventors: Masaki OYAMA, Tokyo (JP); Atsushi KUMITA, Tokyo (JP); Toshikazu JINNOUCHI, Tokyo (JP)

(21) Appl. No.: 16/143,311

(22) Filed: Sep. 26, 2018

(30) Foreign Application Priority Data
Sep. 27, 2017 (JP) 2017-187159

(51) Int. Cl. G07F 17/34; G07F 17/32

(52) U.S. Cl. CPC G07F 17/34; G07F 17/3211

(57) ABSTRACT

The information processor of the present invention comprises a controller programmed to execute the following processes: (1a) performing a random determination to display a game result determined by a random determination on a display, (1b) giving a first benefit when the game result obtained by the process of (1a) satisfies a first condition, (1c) when the first condition is satisfied as a result of repeating the process of (1a) and the process of (1b), a value of a counter of a storage device is counted, and when a second condition is satisfied, a process of resetting the value of the counter, (1d) giving a second benefit when the value of the counter reaches a predetermined value, (1e) allowing acceptance of gaming mediums when the second condition is satisfied, (1f) invalidating the resetting of the value of the counter in the process of (1c) when there is the acceptance of the gaming mediums.

### CROSS-REFERENCE TO RELATED APPLICATION

This Application is Entitled to the benefit of Japanese Pat. App. No. 2017-187159, filed on Sep. 27, 2017.

### BACKGROUND OF THE INVENTION

### 1. Field of Invention

The present invention relates to an information processor and a game control method.

### 2. Description of Related Art

In the related art, there are various types of games to be performed by a home type game console device, a game device installed in a facility, or an information processor such as a smart phone.

For example, a game is played as an expense of consumption (payment) of various gaming mediums (currency in game etc.), and a benefit is given when a predetermined condition is satisfied during the result of the game and the course thereof. Specifically, there are a slot game in which the slot game is played by betting various gaming mediums (currency in a game or the like) and a slot game in which a benefit (payout) is given based on a the gaming mediums and a combination of symbols (game result) displayed on a screen. In such a game, it is based on enjoying by repeating a game (unit game) of one cycle from the start of the game until obtaining the game result (see Patent Document 1 (International Publication No. WO2016/136749A1)).

### BRIEF SUMMARY OF THE INVENTION

In the slot game as described above, when the number of times for which a predetermined condition (a combination of symbols or the like) is satisfied reaches a predetermined number as a result of repeating a unit game in order to induce player's interest (in the case of failure, the number of times for which the predetermined condition is satisfied is reset), it is possible to suggest that a bonus is given.

However, for example, if a predetermined condition for one less than a predetermined number of times is satisfied but failed afterwards and a bonus can not be obtained, as a player, sometimes the motivation for the slot game may decrease.

Therefore, an object of the present invention is to provide an information processor, a game program, and a game control method capable of solving a decline of a player's motivation due to a game failure and being able to induce the game to be continued.

The present invention provides an information processor comprising:

a display for displaying a game result obtained by a random determination,
a storage device, and
a controller programmed to execute:
(1a) a process of performing a random determination to display the game result determined by the random determination on the display,
(1b) a process of giving a first benefit when the game result obtained by the process of (1a) satisfies a first condition,
(1c) when the first condition is satisfied as a result of repeating the process of (1a) and the process of
(1b), a value of a counter of the storage device is counted, and when a second condition is satisfied, a process of resetting the value of the counter of the storage device,
(1d) a process of giving a second benefit when the value of the counter reaches a predetermined value,
(1e) a process of allowing acceptance of a predetermined number of gaming mediums when the second condition is satisfied,
(1f) a process of invalidating the resetting of the value of the counter of the storage device in the process of (1c) when there is the acceptance of the predetermined number of gaming mediums.

According to the above configuration, the number of times for which the first condition is satisfied is counted as a value of the counter as a result of repeating a game for obtaining the game result by the random determination. Then, when the value of the counter reaches a predetermined value, the second benefit is given.

However, since the value of the counter is reset when the second condition is satisfied, as a result of repeating the game, only when the second condition is not satisfied and the first condition of the predetermined number of times is satisfied, the second benefit is given.
However, even if the second condition is satisfied, the resetting of the value of the counter can be canceled when the predetermined number of gaming mediums are accepted.
Therefore, a player of the game can retry to acquire the second benefit to be given only when the first condition is consecutively satisfied with a predetermined number of times without resetting the value of the counter.
As a result, even if a failure (a situation that the second benefit can not be obtained) that the second condition is satisfied is encountered in the game, the failure can be canceled by inputting the predetermined number of gaming mediums. As a result, it is possible to maintain the motivation for the player to acquire the second benefit, and to eliminate the monotony of the game itself. Also, there is an advantage that the possibility of inducing the input of the gaming medium increases as a result of maintaining the motivation for the player to acquire the second benefit.

Further, in the information processor of the present invention, the controller,

in the process of (1e), allows the acceptance of the predetermined number of gaming mediums only when the second condition is satisfied and the value of the counter is one less than the predetermined value.

According to the above configuration, when the game is played in a situation in which the second condition is not satisfied and the first condition is satisfied consecutively with one less than the predetermined number of times, as a result thereof, the second condition is satisfied, and in this case, it is possible to cancel the resetting of the value of the counter on condition that the predetermined number of gaming mediums are accepted.

Thereby, in the game, even though such a failure that as a result of playing the game in a situation where the second condition is not satisfied and the first condition is satisfied consecutively with one less than the predetermined number of times, the second condition is satisfied, is encountered, the failure can be canceled by inputting the predetermined number of gaming mediums. As a result, it is possible to maintain the motivation for the player to acquire the second benefit, and to eliminate the monotony of the game itself. Also, there is an advantage that the possibility of inducing the input of the gaming medium increases as a result of maintaining the motivation for the player to acquire the second benefit.

Further, the present invention provides an information processor comprising:

a display for displaying a matrix-like symbol display area in which a plurality of symbols are rearrangeable,
a storage device, and
a controller programmed to execute:
(2a) a process of determining a combination of symbols to be rearranged in the symbol display area of the display by a random determination and rearranging the combination of the symbols determined by the random determination in the symbol display area of the display,
(2b) a process of giving a first benefit when the combination of the symbols obtained by the process of (2a) satisfies a first condition,
(2c) when the first condition is satisfied as a result of repeating the process of (2a) and the process of (2b), a value of a counter of the storage device is counted, and when a second condition is satisfied, a process of resetting the value of the counter of the storage device,
(2d) a process of giving a second benefit when the value of the counter reaches a predetermined value,
(2e) a process of allowing acceptance of a predetermined number of gaming mediums when the second condition is satisfied, and
(2f) a process of invalidating the resetting of the value of the counter of the storage device in the process of (2c) when there is the acceptance of the predetermined number of gaming mediums.

According to the above configuration, as a result of repeating a slot game, the number of times that the combination of symbols rearranged in the symbol display area satisfies the first condition is counted as a value of the counter.

Then, when the value of the counter reaches a predetermined value, the second benefit is given.
However, since the value of the counter is reset when the combination of the symbols rearranged in the symbols display area satisfies the second condition, as a result of repeating the slot game, only when the second condition is not satisfied and the first condition of the predetermined number of times is satisfied, the second benefit is given.
However, even if the second condition is satisfied, the resetting of the value of the counter can be canceled when the predetermined number of gaming mediums are accepted.
Therefore, a player of the slot game can retry to acquire the second benefit to be given only when the first condition is consecutively satisfied with a predetermined number of times without resetting the value of the counter.
As a result, even if a failure (a situation that the second benefit can not be obtained) that the second condition is satisfied is encountered in the slot game, the failure can be canceled by inputting the predetermined number of gaming mediums. As a result, it is possible to maintain the motivation for the player to acquire the second benefit, and to eliminate the monotony of the slot game itself. Also, there is an advantage that the possibility of inducing the input of the gaming medium increases as a result of maintaining the motivation for the player to acquire the second benefit.

In addition, the present invention provides a game control method comprising the steps of:

(3a) performing a random determination to display a game result determined by the random determination on a display,
(3b) giving a first benefit when the game result obtained by the step of (3a) satisfies a first condition,
(3c) when the first condition is satisfied as a result of repeating the step of (3a) and the step of (3b), a value of a counter of a storage device is counted, and when a second condition is satisfied, resetting the value of the counter of the storage device,
(3d) giving a second benefit when the value of the counter reaches a predetermined value,
(3e) allowing acceptance of a predetermined number of gaming mediums when the second condition is satisfied, and
(3f) invalidating the resetting of the value of the counter of the storage device in the step of (3c) when there is the acceptance of the predetermined number of gaming mediums.

According to the above method, the number of times for which the first condition is satisfied is counted as a value of the counter as a result of repeating a game for obtaining the game result by the random determination. Then, when the value of the counter reaches a predetermined value, the second benefit is given.

However, since the value of the counter is reset when the second condition is satisfied, as a result of repeating the game, only when the second condition is not satisfied and the first condition of the predetermined number of times is satisfied, the second benefit is given.
However, even if the second condition is satisfied, the resetting of the value of the counter can be canceled when the predetermined number of gaming mediums are accepted.
Therefore, a player of the game can retry to acquire the second benefit to be given only when the first condition is consecutively satisfied with a predetermined number of times without resetting the value of the counter.
As a result, even if a failure (a situation that the second benefit can not be obtained) that the second condition is satisfied is encountered in the game, the failure can be canceled by inputting the predetermined number of gaming mediums. As a result, it is possible to maintain the motivation for the player to acquire the second benefit, and to eliminate the monotony of the game itself. Also, there is an advantage that the possibility of inducing the input of the gaming medium increases as a result of maintaining the motivation for the player to acquire the second benefit.

In addition, the present invention provides a non-temporary recording medium storing a game program executed by a computer of an information processor,

the game program controlling the computer to perform:
(4a) a process of performing a random determination to display a game result determined by the random determination on a display,
(4b) a process of giving a first benefit when the game result obtained by the process of (4a) satisfies a first condition,
(4c) when the first condition is satisfied as a result of repeating the process of (4a) and the process of
(4b), a value of a counter of a storage device is counted, and when a second condition is satisfied, a process of resetting the value of the counter of the storage device,
(4d) a process of giving a second benefit when the value of the counter reaches a predetermined value,
(4e) a process of allowing acceptance of a predetermined number of gaming mediums when the second condition is satisfied, and
(4f) a process of invalidating the resetting of the value of the counter of the storage device in the process of (4c) when there is the acceptance of the predetermined number of gaming mediums.

According to the above configuration, the number of times for which the first condition is satisfied is counted as a value of the counter as a result of repeating a game for obtaining the game result by the random determination. Then, when the value of the counter reaches a predetermined value, the second benefit is given.

However, since the value of the counter is reset when the second condition is satisfied, as a result of repeating the game, only when the second condition is not satisfied and the first condition of the predetermined number of times is satisfied, the second benefit is given.
However, even if the second condition is satisfied, the resetting of the value of the counter can be canceled when the predetermined number of gaming mediums are accepted.
Therefore, a player of the game can retry to acquire the second benefit to be given only when the first condition is consecutively satisfied with a predetermined number of times without resetting the value of the counter.
As a result, even if a failure (a situation that the second benefit can not be obtained) that the second condition is satisfied is encountered in the game, the failure can be canceled by inputting the predetermined number of gaming mediums. As a result, it is possible to maintain the motivation for the player to acquire the second benefit, and to eliminate the monotony of the game itself. Also, there is an advantage that the possibility of inducing the input of the gaming medium increases as a result of maintaining the motivation for the player to acquire the second benefit.

It is possible to provide an information processor and a game control method capable of solving a decline of a player's motivation due to a game failure and being able to induce the game to be continued.

### BRIEF DESCRIPTION OF THE DRAWINGS

FIG. 1 is an illustrative view showing a display state of a smartphone (an information processor).

FIG. 2 is an illustrative view of a network environment between the smartphone and a server.

FIG. 3 is a block diagram showing an electric configuration of the smartphone (the information processor).

FIG. 4 is an illustrative view of an effective area of “WAYS BET” of a slot game.

FIG. 5 is an illustrative view of a winning determination example in the “WAYS BET” of the slot game.

FIG. 6 is an illustrative view of symbol columns of video reels of the slot game.

FIG. 7 is an illustrative view of a symbol combination table of the slot game.

FIG. 8 is a flowchart showing a main control process.

FIG. 9 is a flowchart showing a bet start check process.

FIG. 10 is an illustrative view of a slot game displayed on a display.

FIG. 11 is an illustrative view of a slot game displayed on a display.

FIG. 12 is an illustrative view of a slot game displayed on a display.

### DETAILED DESCRIPTION OF THE PREFERRED EMBODIMENT

### Embodiments

The information processor of the present invention will be described based on the drawings.

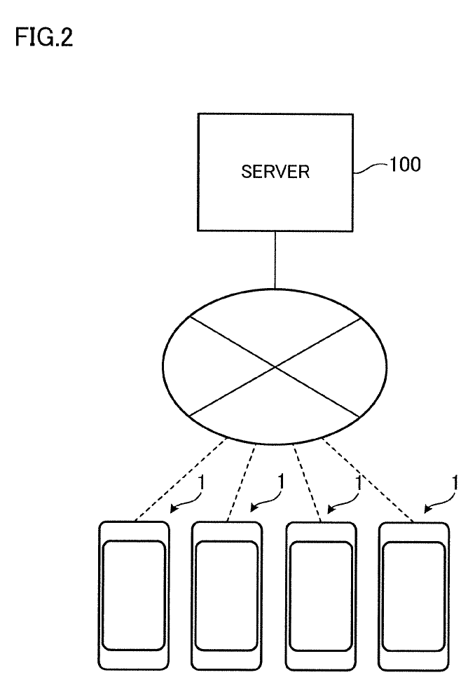

The game executed in the present embodiment can be executed as application software (program, game data) by being installed in a portable information processor such as a smart phone, a portable computer, a laptop computer, a notebook computer, a tablet type personal computer, a handheld type personal computer, and a PDA (Personal Data Assistant). The application software for executing this game is downloaded from a server (see FIG. 2) or the like by communication means and stored in a storage device in the information processor. Wherein, the communication means may be a bidirectional communication path such as the Internet or a cable television, or may be a broadcast that transmits information only in one direction.

In addition, the application software for executing the game may also be stored in a recording medium such as a floppy disk, a CD-ROM, a DVD-ROM, an MO (magneto-optical disk), a flash memory or the like, and read out from the recording medium as necessary and then installed in the storage device in the information processor.

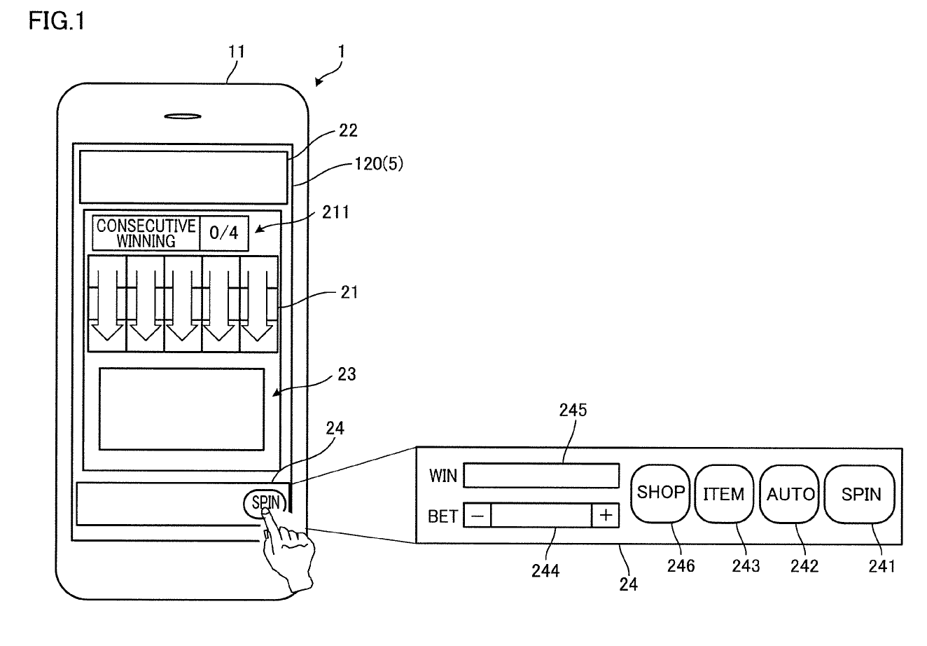

In the present embodiment, as the information processor, the smartphone 1 shown in FIG. 1 will be described as an example. In addition, in the following description, the smartphone 1 will be described, but the process and operation of the smartphone 1 can be replaced with the invention of a program or game control method.

(Online)

In addition, the game executed in the present embodiment is a slot game and is executed as an online game. Specifically, as shown in FIG. 2, a server 100 managed by a slot game operating organization and smartphones 1 operated by a large number of players are connected via a computer network (Internet).

In this way, the slot game is executed as online. As a result, the player can download the slot game application software from the server 100, install it in the smartphone 1, and execute the slot game. Further, in the server 100 (management system), exchange of credits possessed by the player (out-of-game currency which can be used outside the game) to in-game currency (coins as gaming mediums) usable in the slot game and the in-game currency possessed by the player can be managed.

(Configuration of Smartphone 1)

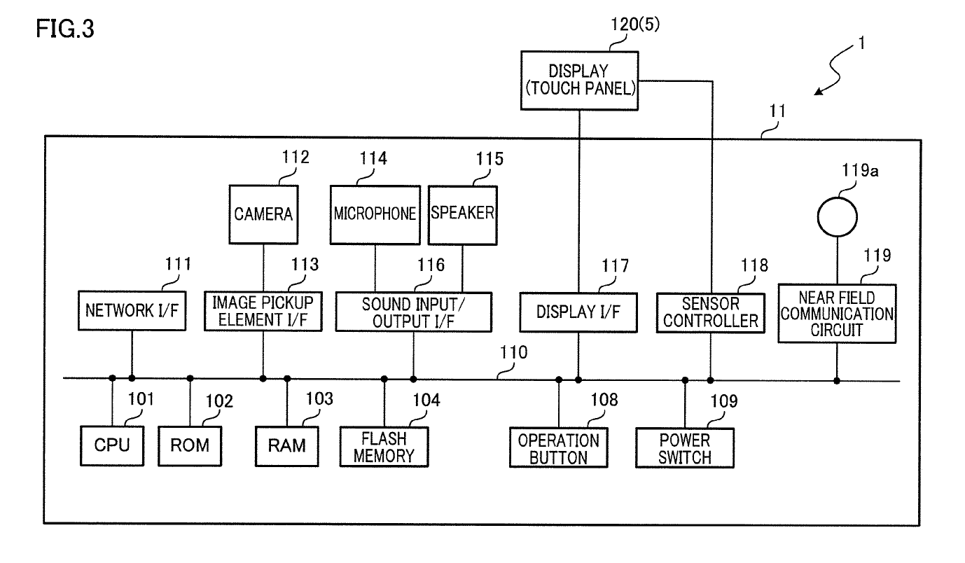

As shown in FIG. 3, the smartphone 1 includes a CPU 101, a ROM 102, a RAM 103, a flash memory 104, an operation button 108, a power switch 109, a bus line 110, a network I/F 111, a camera 112, an image pickup element I/F 113, a microphone 114, a speaker 115, a sound input/output I/F 116, a display I/F 117, a sensor controller 118, a short-range communication circuit 119, and an antenna 119a of the short-range communication circuit 119 provided in a cabinet 11. In addition, on the front surface of the cabinet 11, the display 120 having a touch panel 5 (input unit) is installed.

The display 120 is configured to display an image. As a display method of the display 120, various display methods such as a liquid crystal method, an organic electroluminescence method, a CRT (Cathode Ray Tube) method, a plasma method and the like are exemplified.

The CPU (Central Processing Unit) 101 controls the overall operation of the smartphone 1. The ROM (Read Only Memory) 102 stores a program used for driving the CPU 101, such as an IPL (Initial Program Loader).

The RAM (Random Access Memory) 103 is used as a work area of the CPU 101. The flash memory 104 stores various kinds of data such as an application software (program), a communication program, an image data, and a sound data for executing the game according to this embodiment (game data necessary for a slot game such a symbol column, a symbol combination table of a video reel to be described later). The operation button 108 is a button that is operated when the smartphone 1 is initially set. The power switch 109 is a switch for switching ON/OFF of the power of the smartphone 1.

The network I/F (Interface) 111 is interface for performing a data communication with the server 100 and the like by utilizing a communication network such as the Internet. The camera 112 is a kind of built-in type image pickup unit that captures an image of a subject under the control of the CPU 101 to obtain image data. The image pickup element I/F 113 is a circuit that controls driving of the camera 112. The microphone 114 is a kind of built-in type sound collecting unit for inputting a sound. The sound input/output I/F 116 is a circuit for processing input and output of sound signals between the microphone 114 and the speaker 115 under the control of the CPU 101. The display I/F 117 is a circuit that transmits image data to the display 120 under the control of the CPU 101. The sensor controller 118 is a circuit that receives an input from the touch panel 5 provided on the display 120. The short-range communication circuit 119 is a communication circuit such as an NFC (Near Field Communication) (registered trademark), a Bluetooth (registered trademark), or the like. The bus line 110 is an address bus, a data bus, or the like for electrically connecting each component such as the CPU 101.

(Overview of Game Executed by Smartphone 1)

In the smartphone 1 having the above configuration, the CPU 101 is programmed to execute the slot game application software.

In the smartphone 1, the game application software is executed, and after the various games start effect image or the like is displayed, when a selected image to start the “slot game” is selected by the touch panel 5, the slot game is started (described in detail later). For example, when the slot game is started, as shown in FIG. 1, a slot game is executed in which a plurality of symbols are rearranged in a symbol display area 21 composed of 15 areas in a matrix of 5 rows×3 columns (described in detail later).

Note that a plurality of types of slot games to be selected may be prepared, and the rule, the payout mode, and the effect image may be different depending on the type of slot game to be executed. For example, in a certain type of “slot game”, a slot game is executed in which a plurality of symbols are rearranged in a symbol display area composed of 9 areas in a matrix of 3 rows×3 columns. In this slot game, a winning is determined by a combination of symbols rearranged on a payline (winning determination) set only in the middle of the symbol display area.

Here, when starting a slot game in the present embodiment, it is basically to consume a predetermined amount of coins (gaming mediums, in-game currency) possessed by a player, and the slot game is started as the consumption of the coins. In addition, when a predetermined condition is satisfied, it is possible to start a slot game without consuming any coin (for example, a slot game can be played without consuming any coin up to a predetermined number of times a day). The coin possessed by a player is an electronic valuable information, the player accesses from the smartphone 1 to the server 100, and can exchange a credit (out-of-game currency which can be used outside a game) for the coin according to the payment method specified by the slot game operating organization. Besides, the coin possessed by a player may also be consumed as an expense in order to obtain an effect of affecting the slot game, or is consumed as an expense to change the appearance of a character that symbolizes the player, and is a wide variety to use.

In addition, the “in-game currency” is not particularly limited, and for example, when the slot game according to the present embodiment is executed by a gaming machine (slot machine) or the like installed in a hall or the like, it may be a medal, a token, an electronic money, a ticket, and the like. The ticket is not particularly limited, and a barcoded ticket may be adopted for example. Alternatively, the in-game currency may be a game point not including valuable information.

(Slot Game: Definitions)

In the slot game executed in the present embodiment, a plurality of symbols are stopped and displayed (rearranged) in the symbol display area 21 after variation (scrolling video of the reel), and the benefit (such as the payout or item advantageous/disadvantageous to the player) is given by the combination of the symbols displayed in the symbol display area 21 (see FIG. 1). In addition, a state in which a plurality of symbols are stop-displayed after variation in the symbol display area 21 is referred to as “rearrangement”.

A “coin” may be given in the benefit given based on the combination of the symbols displayed in the symbol display area 21.

The “unit game” is a series of operations from the start of acceptance of a bet to a state in which a prize is established (the combination of symbols satisfies a predetermined relationship). To put it differently, the unit game includes a single bet time for accepting a bet, a single game time of rearranging stopped symbols, and a single payout time of a payout process of awarding a payout.

(Slot Game Screen)

Next, the slot game screen displayed on the display 120 of the smartphone 1 will be described.

As shown in FIG. 1, when a slot game is executed, a slot game screen is displayed on the display 120. In the slot game screen, the symbol display area 21 composed of 15 areas in a matrix of 5 rows×3 columns, a consecutive winning counter display area 211, a game information display area 22 for displaying information (the number of coins currently possessed, etc.) increasing/decreasing with the execution of the slot game or the like, an effect display area 23 for displaying a dynamic image such as a game character, a still image, and a message in accordance with the development of the slot game, and an operation display area 24 operated by the player for the progress of the slot game are displayed. In the operation display area 24, a spin button 241, an AUTO button 242, an ITEM button 243, a bet button 244, a WIN display unit 245, and a shop button 246 are displayed.

The touch panel 5 that transmits the slot game screen is provided on the entire surface of the display 120. The touch panel 5 makes it possible to detect the coordinate of the site touched by the player's finger or the like. Thus, for example, by touching the image of the spin button 241, one slot game (unit game) can be executed. In addition, by touching the image of the AUTO button 242, the slot game can be consecutively performed. Further, when the image of the ITEM button 243 is touched, the player can select and use the item (game effect that affects the slot game) acquired in the past. In addition, when the image of the shop button 246 is touched, it is possible to access the server 100 from the smartphone 1 and move to a shop in which the credit (out-of-game currency which can be used outside the game) can be exchanged for the coin.

(Symbol Display Area 21)

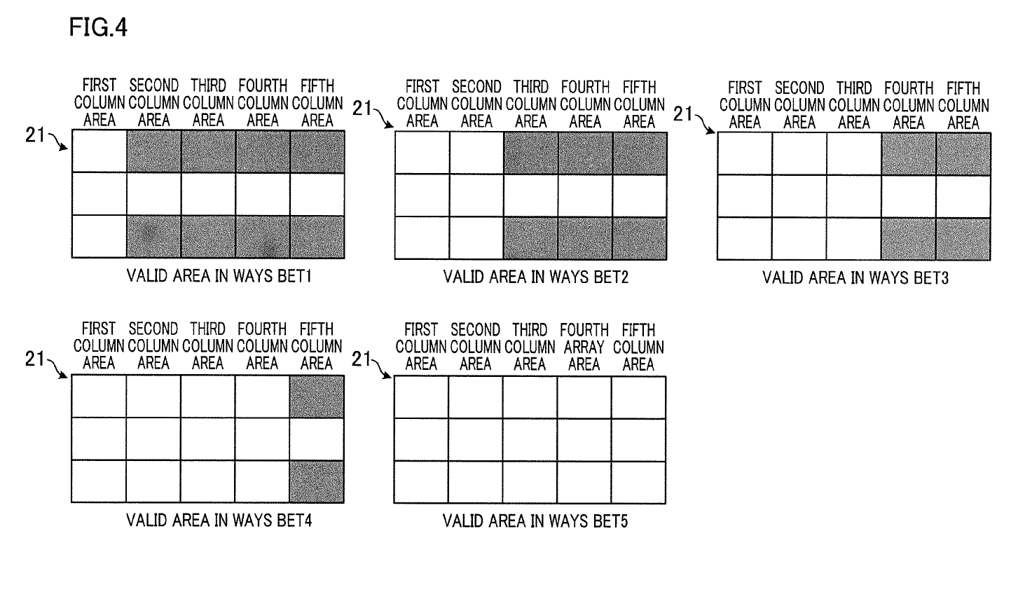

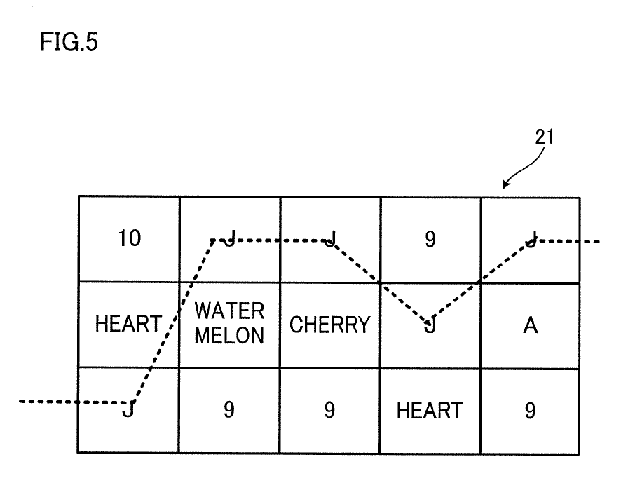

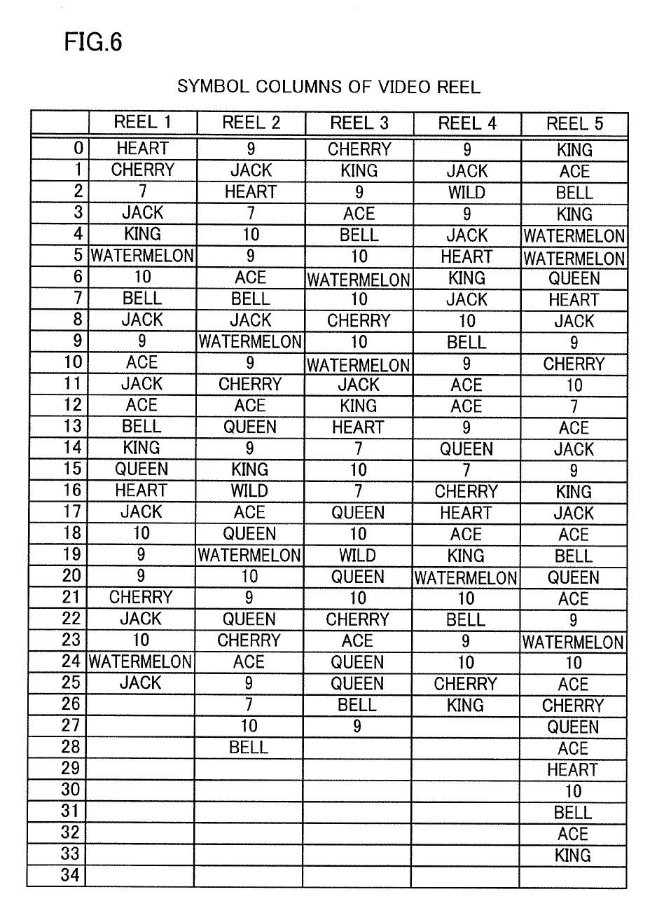

As described above, in the symbol display area 21 of the slot game, as shown in FIGS. 4 and 5, five column areas (the first column area to the fifth column area) each divided into three areas of an upper row, a middle row, and a lower row (three rows) are set. Also, video reels 3 (REEL 1, REEL 2, REEL 3, REEL 4, REEL 5) are displayed in the first to fifth column areas, respectively. In the video reels 3 of the slot game of the present embodiment, operations of rotating and stopping mechanical reels on which a plurality of symbols are drawn on their circumferential surfaces are represented by images. Symbol columns composed of a plurality of symbols are allocated to the video reels 3 (REEL 1, REEL 2, REEL 3, REEL 4, REEL 5) (see FIG. 6).

In the symbol display area 21, the symbol columns allocated to the video reels 3 (REEL 1, REEL 2, REEL 3, REEL 4, REEL 5, REEL 6) are respectively scrolled and stopped after a lapse of a predetermined time. As a result, a part of each symbol column (three consecutive symbols) is sequentially displayed in the symbol display area 21. In the first to fifth column areas of the symbol display area 21, one symbol is allocated to each of the upper, middle, and lower areas is displayed accordingly to the video reels 3 (REEL 1, REEL 2, REEL 3, REEL 4, REEL 5). That is, in the symbol display area 21, 15 symbols of 5 columns×3 rows are displayed.

As described above, in the symbol display area 21, 15 areas are arranged in a matrix pattern so that five column areas (a plurality of columns) and three rows (a plurality of rows) of the upper row, the middle row, and the lower row cross each other.

In the slot game, the determination of winning adopts “LEFT TO RIGHT” type. First, the area as the object of the winning determination is determined from the 15 areas in 5 columns×3 rows of the symbol display area 21 by selecting five stages of the WAYS BET (WAYS BET 1, WAYS BET 2, WAYS BET 3, WAYS BET 4, WAYS BET 5) (determination of an valid area) (see FIG. 4). Then, if symbols stopped in the area as the object of the winning determination are consecutively connected in a predetermined number from the first column area to the fifth column area, it becomes the winning (see FIG. 5).

Wherein, the selection of five stages of WAYS BET (WAYS BET 1, WAYS BET 2, WAYS BET 3, WAYS BET 4, WAYS BET 5) is performed by touching the “+” button and “−” button (see FIG. 1) of the bet button 244. In addition, one coin is required to select WAYS BET 1. Also, three coins are required to select WAYS BET 2. In addition, seven coins are required to select WAYS BET 3. In addition, to select WAYS BET 4, fifteen coins are required. In addition, to select WAYS BET 5, twenty-five coins are required.

More specifically, as shown in FIG. 4, when “WAYS BET 1” is selected, the upper row, the middle row, and the lower row of the first column area, the middle row of the second column area, the middle row of the third column area, the middle row of the fourth column area, and the middle row of the fifth column area of the symbol display area 21 become the object of the winning determination (valid). In addition, when “WAYS BET 2” is selected, the upper row, the middle row, and the lower row of the first column area, the upper row, the middle row and the lower row of the second column area, the middle row of the third column area, the middle row of the fourth column area, and the middle row of the fifth column area of the symbol display area 21 become the object of the winning determination (valid). In addition, when “WAYS BET 3” is selected, the upper row, the middle row, and the lower row of the first column area, the upper row, the middle row and the lower row of the second column area, the upper row, the middle row and the lower row of the third column area, the middle row of the fourth column area, and the middle row of the fifth column area of the symbol display area 21 become the object of the winning determination (valid). In addition, when “WAYS BET 4” is selected, the upper row, the middle row, and the lower row of the first column area, the upper row, the middle row and the lower row of the second column area, the upper row, the middle row and the lower row of the third column area, the upper row, the middle row and the lower row of the fourth column area, and the middle row of the fifth column area of the symbol display area 21 become the object of the winning determination (valid). In addition, when “WAYS BET 5” is selected, the upper row, the middle row, and the lower row of the first column area, the upper row, the middle row and the lower row of the second column area, the upper row, the middle row and the lower row of the third column area, the upper row, the middle row and the lower row of the fourth column area, and the upper row, the middle row and the lower row of the fifth column area of the symbol display area 21 become the object of the winning determination (valid).

For example, as shown in FIG. 5, when the “WAYS BET 5” is selected, all areas of the symbol display area 21 become the objects of the winning determination (validated). Then, as shown in FIG. 5, when the symbols “J: Jack” are respectively stopped in the lower row of the first column area, the upper row of the second column area, the upper row of the third columns area, the middle row of the fourth column area, the upper row of the fifth row column area, the symbols “J: Jack” are consecutively connected up to five from the first column area to the fifth column area (“LEFT TO RIGHT”) to establish one winning. As described above, in the “LEFT TO RIGHT” type, even if the symbols are stopped in a wild disorder at a glance, if they are connected consecutively from the first column area to the fifth column area, the winning is determined. In addition, in the slot game of the present embodiment, the “LEFT TO RIGHT” type is adopted, but adopting a line type in which a line formed by connecting only the middle row of the column area of each column is a winning line is also possible. Further, a scatter type may be adopted for determining the winning according to the number of symbols of the same type displayed in the symbol display area 21.

(Consecutive Winning Counter Display Area 211)

As shown in FIG. 1, the number of current consecutive winnings is displayed in the consecutive winning counter display area 211. The number of consecutive winnings is a value counted when the slot game (unit game) is performed and the combination of symbols rearranged in the symbol display area 21 constitutes any winning (giving payout, etc.) (corresponding to satisfying the first condition). However, when the slot game is performed and the combination of symbols rearranged in the symbol display area 21 not constitute any winning (corresponding to the case where the second condition is satisfied), the number of consecutive winnings is reset (to be “0”).

When the number of consecutive winnings displayed in the consecutive winning counter display area 211 reaches “4”, 20 free games are given (corresponding to the second benefit). This free game to be given is a benefit in which it is possible to perform 20 slot games without consuming any coin.

(Symbol Columns of the Video Reels)

Next, with reference to FIG. 6, the configuration of the symbol columns included in the video reels 3 of the slot game will be described (symbol random determination table).

As shown in FIG. 6, symbol columns composed of the symbols corresponding to code numbers “0” to “33” are allocated to “Reel 1”, “Reel 2”, “Reel 3”, “Reel 4”, and “Reel 5” of the video reels 3, respectively. Normal symbols such as “7”, “HEART”, “BELL”, “WATERMELON”, “CHERRY”, “ACE (A)”, “KING (K)”, “QUEEN (Q)”, “JACK (J)”, “10”, “9” and “WILD” symbol which is a universal symbol (symbol of almighty) as an alternate of another symbol are included in the types of symbols arranged in each symbol column of the video reels 3.

(Symbol Combination Table)

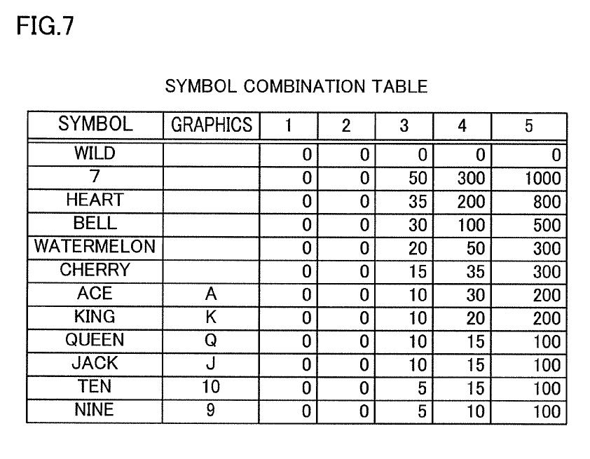

Next, with reference to 7, the symbol combination table is illustrated. FIG. 7 is an illustrative view of a symbol combination table used in the slot game according to the present embodiment.

The symbol combination table of the slot game defines the symbol combination (number of symbols) of symbols related to a winning (WIN) and the payout amount (payout). In the slot game, the scrolling of the symbol column of the video reels 3 is stopped, and in an area of the symbol display area 21, which becomes the object of the winning determination by the WAYS BET described above, when a predetermined types of symbols are connected up to a predetermined number from the first column area to the fifth column area, the winning is established. Then, according to the winning, a benefit such as a payout is given to the player.

Basically, for each symbol of “7”, “HEART”, “BELL”, “WATERMELON”, “CHERRY”, “A”, “K”, “Q”, “J”, “10”, “9”, when symbols of the same type are connected with each other up to 3 (3 Kind), 4 (4 Kind), or 5 (5 Kind) by the WAYS BET from the first column area to the fifth column area in the area which is the object of the winning determination, the winning is established. For the symbol of “WILD”, it is substituted for each type of symbol of “7”, “HEART”, “BELL”, “WATERMELON”, “CHERRY”, “A”, “K”, “Q”, “J”, “10”, and “9”.

For example, when “WAYS BET 3” is selected, the upper row, the middle row, and the lower row of the first column area, the upper row, the middle row and the lower row of the second column area, the upper row, the middle row and the lower row of the third column area, the middle row of the fourth column area, and the middle row of the fifth column area of the symbol display area 21 become the object of the winning determination (valid). Then, the scrolling of each symbol column of the video reels 3 (REEL 1, REEL 2, REEL 3, REEL 4, REEL 5) is stopped, and when the symbols “7” are respectively stopped in the lower row of the first column area, the upper row of the second column area, and the middle row of the third column area, the symbols “7” are connected with each other up to three from the first column area to the third column area (“LEFT TO RIGHT”) to establish a winning (“3 Kind of “7” is established). In this case, referring to the symbol combination table of FIG. 7, “50” is determined as the payout amount of coins. Then, a payout is given based on the determined payout amount of the coins.

In addition, in the slot game, the required bet amount (WAYS BET 1: 1 coin, WAYS BET 2: 3 coins, WAYS BET 3: 7 coins, WAYS BET 4: 15 coins, WAYS BET 5: 25 coins) are determined in each selection of 5 stages of WAYS BET, respectively. In addition, it is also possible to select multiple WAYS BETs in the unit game. For example, when WAYS BET 3 (7 coins) is selected up to three times, 21 coins (“7”×“3”=21) are required for the total bet amount, but when 3 Kind of “7” is established, “50”×“3”=“150” is determined as the payout amount of coins.

[Contents of Program]

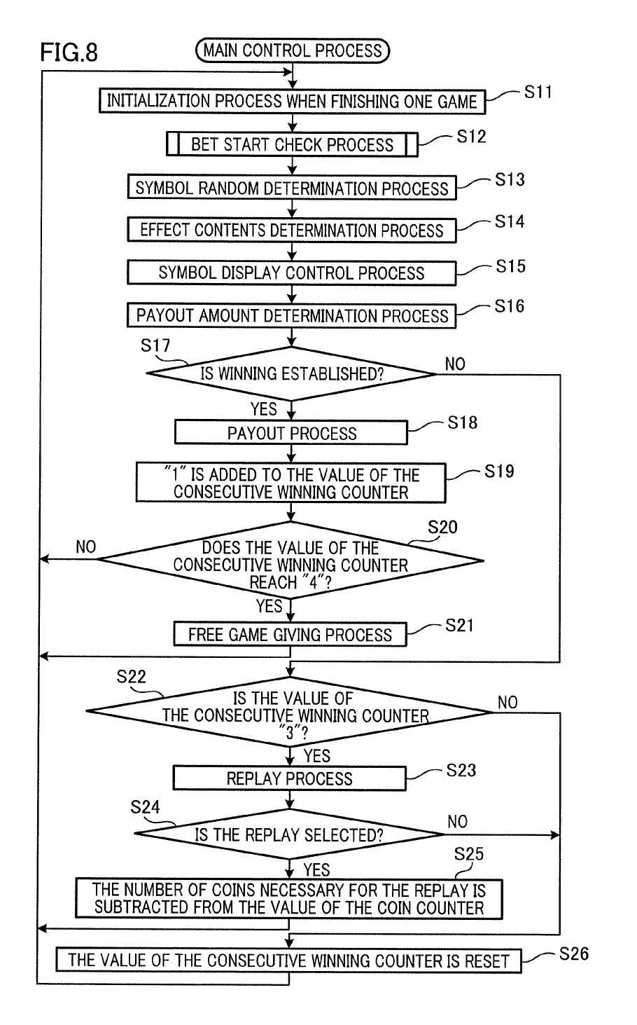

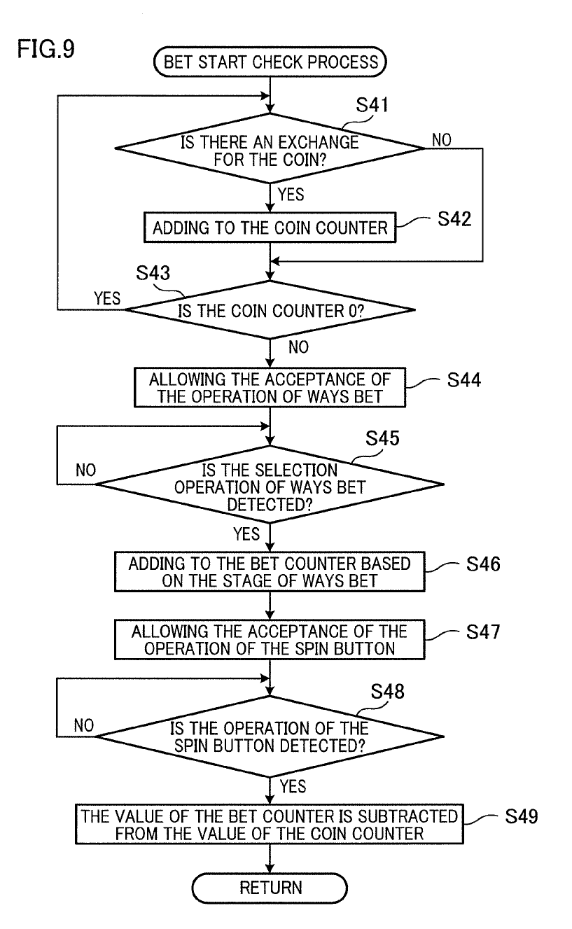

Next, a program of a slot game executed by the smartphone 1 will be described with reference to FIG. 8 to FIG. 9.

(Main Control Process)

First, with reference to FIG. 8, the main control process will be described.

First, in order to start the slot game, the CPU 101 performs an initialization process when finishing one game (S11). For example, unnecessary data for each unit game in the work area of the flash memory 104, such as the WAYS BET enabled in the previous unit game and the symbol determined to be displayed in the symbol display area 21 by the random determination is cleared. In addition, the value of the consecutive winning counter described below is not cleared.

Next, the CPU 101 performs a bet start check process to be described later (S12). In this process, an input check such as WAYS BET (WAYS BET 1, WAYS BET 2, WAYS BET 3, WAYS BET 4, WAYS BET 5) selected by the touch panel 5 or the like is performed. At this time, as shown in FIG. 4, according to the selection of WAYS BET, in order to distinguish from the area (black frame) which is not the object of the winning determination, the area which is the object of the winning determination in the symbol display area 21 is displayed in a white frame. In this way, it is possible to visually distinguish the area which is the object of the winning determination and the area which is not the object of the winning determination.

Next, the CPU 71 performs a symbol random determination process (S13). In this symbol random determination process, the symbol column of the video reels 3 shown in FIG. 6 is used to determine a to-be-stopped symbol by the random determination from a plurality of symbols arranged in each symbol column (REEL 1, REEL 2, REEL 3, REEL 4, REEL 5) of the video reels 3. The to-be-stopped symbol is data of five symbols of the plurality of symbols constituting each symbol column of the video reels 3 to be displayed in the respective middle rows of the first to fifth row areas of the symbol display area 21. As a result, the 15 symbols displayed in the symbol display area 21 are determined.

For example, in the REEL 1 of the video reels 3, when a code number “21” is selected by the random determination from 26 symbols (code numbers “0” to “25”) constituting the symbol column, the symbol of “CHERRY” corresponding to the code number “21” is determined as the to-be-stopped symbol. In addition, in the REEL 2, when a code number “10” is selected by the random determination from 29 symbols (code numbers “0” to “28”) constituting the symbol column, the symbol of “9” corresponding to the code number “10” is determined as the to-be-stopped symbol. In addition, in the REEL 3, when a code number “8” is selected by the random determination from 28 symbols (code numbers “0” to “27”) constituting the symbol column, the symbol of “CHERRY” corresponding to the code number “8” is determined as the to-be-stopped symbol. In addition, in the REEL 4, when a code number “7” is selected by the random determination from 27 symbols (code numbers “0” to “26”) constituting the symbol column, the symbol of “J” corresponding to the code number “7” is determined as the to-be-stopped symbol. In addition, in the REEL 5, when a code number “6” is selected by the random determination from 34 symbols (code numbers “0” to “33”) constituting the symbol column, the symbol of “Q” corresponding to the code number “6” is determined as the to-be-stopped symbol.

Then, the CPU 101 stores the five determined to-be-stopped symbols in the symbol storing area provided in the flash memory 104.

Next, the CPU 71 performs an effect contents determination process (S14). The CPU 101 extracts an effect-use random number and determines which one of a plurality of predetermined effect contents by the random determination.

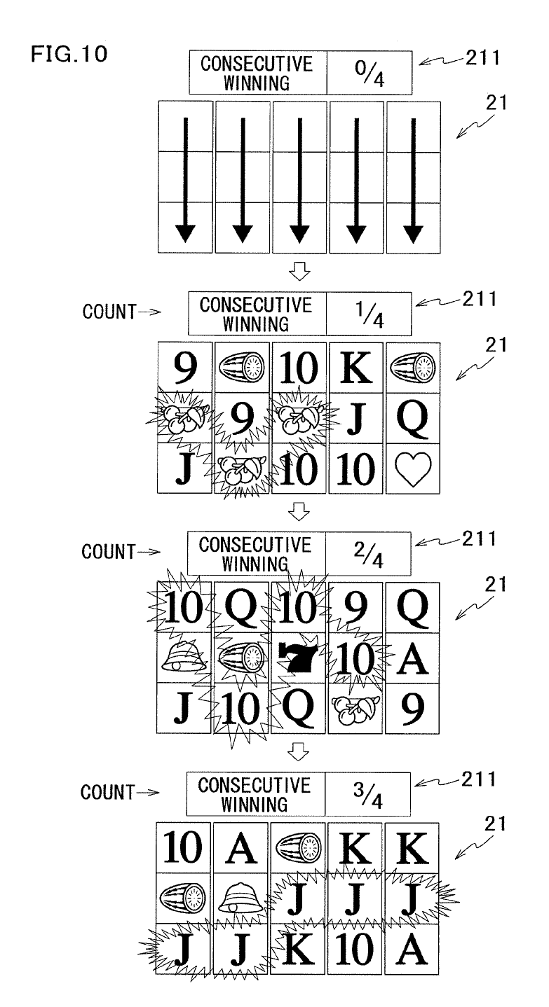

Next, the CPU 101 performs a symbol display control process (S15). In the symbol display control process, the scrolling of each symbol column of the video reels 3 is started, and after a predetermined time, the five to-be-stopped symbols determined in the symbol random determination process in S13 are sequentially stopped respective middle rows of the first column area to the fifth column area of the symbol display area 21. That is, fifteen symbols including the to-be-stopped symbol are rearranged in the symbol display area 21. For example, as described above, in REEL 1, the symbol “CHERRY” is determined as a to-be-stopped symbol, in REEL 2, the symbol “9” is determined as a to-be-stopped symbol, in REEL 3, the symbol “CHERRY” is determined as a to-be-stopped symbol, in REEL 4, the symbol “J” is determined as a to-be-stopped symbol, and in REEL 5, the symbol “Q” is determined as a to-be-stopped symbol, and in this case, the “CHERRY”, “9”, “CHERRY”, “J”, and “Q” are respectively rearranged in respective middle rows of the first column area to the fifth column area of the symbol display area 21. In addition, symbols corresponding to preceding and succeeding code numbers of the to-be-stopped symbol are rearranged in the respective upper rows and the lower rows of the first to fifth row areas of the symbol display region 21 (with reference to the second symbol display area 21 from the top in FIG. 10).

Next, the CPU 101 performs a payout amount determination process (S16). In this process, based on the symbol combination table of slot games (see FIG. 7) stored in the flash memory 104, it is determined whether symbols rearranged in the symbol display area 21 are connected up to the predetermined number from the first column area to the fifth column area in the area which is the object of the winning determination by the WAYS BET described above to establish a winning. Then, according to the winning, a benefit such as a payout is given. The given payout is stored in the payout amount storage area provided in the flash memory 104.

For example, when “WAYS BET 3” is selected, the upper row, the middle row, and the lower row of the first column area, the upper row, the middle row and the lower row of the second column area, the upper row, the middle row and the lower row of the third column area, the middle row of the fourth column area, and the middle row of the fifth column area of the symbol display area 21 become the object of the winning determination (valid). Then, as shown in FIG. 10, when the symbols “CHERRY” are respectively stopped in the middle row of the first column area, the lower row of the second column area, and the middle row of the third columns area, the symbols “CHERRY” are consecutively connected up to three from the first column area to the third column area (“LEFT TO RIGHT”) to establish one winning. At this time, in order to visually confirm that the winning of 3 Kind of “CHERRY” is established, as shown in FIG. 10, the three “CHERRY” symbols are blinked and displayed after glowing. Then, as the 3 Kind of “CHERRY”, the symbol combination table of FIG. 7 is referred to, and coins of “15” are determined as a payout and stored in the payout amount storage area provided in the flash memory 104.

Next, the CPU 101 determines whether or not the winning has been established (corresponding to the first condition) (S17). The “winning has been established” means a state in which a predetermined types of symbols from the first column area to the fifth column area are connected up to the predetermined number in the area which is the object of the winning determination by the WAYS BET described above to establish a winning and a payout is given (see FIG. 7). Therefore, when 3 Kind of “CHERRY” shown in FIG. 10 is established, the winning is established.

Then, when the winning has been established (S17: YES), the CPU 101 performs a payout process (S18). The CPU 101 adds the value stored in the payout amount storage area to the value of the coin number counter provided in the flash memory 104. For example, when “15” is stored in the payout amount storage area in the payout amount determination process of S16, “15” is added to the value of the coin counter (corresponding to giving the first benefit).

After the process in S18, the CPU 101 adds “1” to the value of the consecutive winning counter provided in the flash memory 104 (S19).

Next, the CPU 101 determines whether or not the value of the consecutive winning counter obtained by adding “1” in the process of S19 has reached “4” (S20). Then, when the value of the consecutive winning counter has not reached “4” (S20: NO), the process goes to S11.

On the other hand, when the value of the consecutive winning counter has reached “4” (S20: YES), 20 free games are given (S21: corresponding to the second benefit). As a result, the player can perform 20 slot games without consuming any coin. In addition, in the 20 free games, the WAYS BET selected in the process of S12 is inherited.

Then, when the 20 free games are completed, the value of the consecutive winning counter is reset, and after returning to “0”, the process goes to S11.

On the other hand, when the winning has not been established in the process of S17 (S17: NO), the CPU 101 determines whether or not the value of the consecutive winning counter is “3” (S22). Then, when the value of the consecutive winning counter is not “3” (S22: NO), the value of the consecutive winning counter is reset and returned to “0” (S26). Thereafter, the process proceeds to S11. In addition, in the present embodiment, “the winning has not been established” corresponds to the case where the second condition is satisfied according to the determination of S17.

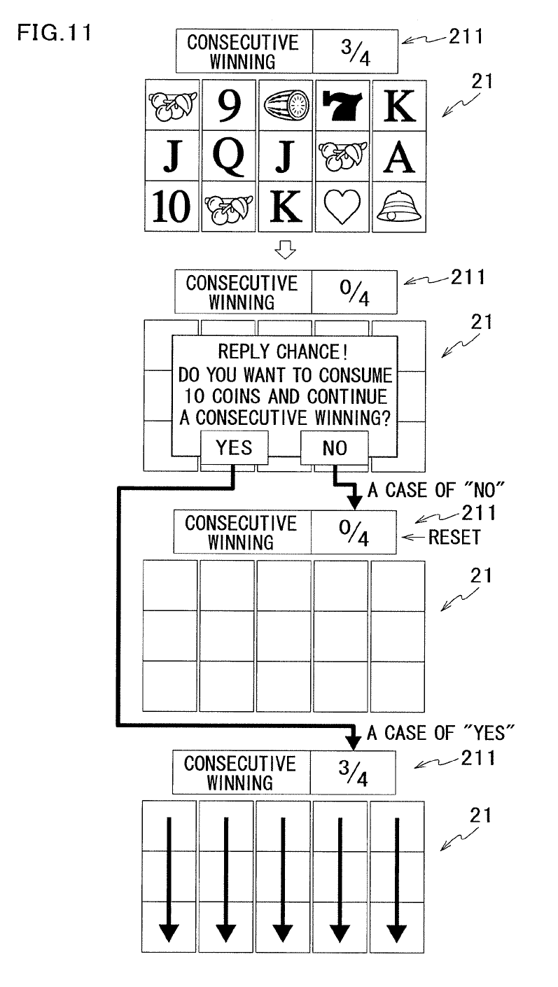

On the other hand, when the value of the consecutive winning counter is “3” (S22: YES), the CPU 101 performs a replay process (S23). In this replay process, as shown in FIG. 11, a message “Replay chance! Do you want to consume 10 coins and continue a consecutive winning?” is displayed in the display 120 (the display area of the symbol display area 21). At that time, a “YES” button (selection of replay) and a “NO” button are displayed on the display 120. As a result, touch (corresponding to acceptance) of “YES” button (selection of replay) is allowed (acceptance of gaming mediums of 10 coins is allowed).

Then, the CPU 101 determines whether the “YES” button displayed on the display 120 is touched (S24). That is, it is determined whether or not the replay has been selected. If the “YES” button is not touched (when replay is not selected) (S24: NO), the value of the consecutive winning counter is reset and returned to “0” (S26). Thereafter, the process proceeds to S11. Further, the case where the “YES” button is not touched (when the replay is not selected) also includes a case where the “NO” button displayed on the display 120 is touched and a case where a predetermined time has elapsed without touching any of the “YES” button and the “NO” buttons.

On the other hand, if the “YES” button is touched (when replay is selected) (S24: YES), “10” is subtracted from the value of the coin counter (S25). Thereafter, the process proceeds to S11.

As a result, only when the winning is not established in a previous state (a state in which the consecutive winning counter is “3”) in which the “20 free games” given when the value of the consecutive winning counter reaches “4” is obtained (the second condition is satisfied), 10 coins are consumed by touching the “YES” button (selection of replay) displayed on the display 120 to avoid “the process goes to S26 to reset the value of the consecutive winning counter”. That is, as an expense of 10 coins, resetting of the value of the consecutive winning counter can be invalidated.

In addition, in the replay process of S23, once the value of the consecutive winning counter is reset and the “YES” button is touched (when the replay is selected), a process of restoring the value of the consecutive winning counter to be the value before resetting. This case is also included in invalidating the resetting of the value of the consecutive winning counter as an expense of 10 coins.

Next, the procedure of the main control process will be described based on the slot game image displayed on the display 120.

For example, as a result of the symbol random determination process (S13) and the symbol display control process (S15), it is assumed that a winning of 3 Kind of “CHERRY” is established as shown in the second symbol display area 21 from the top in FIG. 10. As a result, “1” is added to the value of the consecutive winning counter provided in the flash memory 104, and the value of “1/4” is displayed in the consecutive winning counter display area 211 of the display 120.

Thereafter, since the value of the consecutive winning counter has not reached “4” (S20), the process proceeds to the next slot game (goes to S11). Then, as a result of the symbol random determination process (S13) and the symbol display control process (S15) of the next slot game, it is assumed that a winning of 4 Kind of “10” is established as shown in the third symbol display area 21 from the top in FIG. 10. As a result, “1” is added to the value of the consecutive winning counter provided in the flash memory 104, and the value of “2/4” is displayed in the consecutive winning counter display area 211 of the display 120.

Thereafter, since the value of the consecutive winning counter has not reached “4” (S20), the process proceeds to the next slot game (goes to S11). Then, as a result of the symbol random determination process (S13) and the symbol display control process (S15) of the next slot game, it is assumed that a winning of 5 Kind of “J” is established as shown in the fourth symbol display area 21 from the top in FIG. 10. As a result, “1” is added to the value of the consecutive winning counter provided in the flash memory 104, and the value of “3/4” is displayed in the consecutive winning counter display area 211 of the display 120.

Thereafter, since the value of the consecutive winning counter has not reached “4” (S20), the process proceeds to the next slot game (goes to S11). Then, as a result of the symbol random determination process (S13) and the symbol display control process (S15) of the next slot game, it is assumed that the winning is not established (S17: NO) as shown in the first symbol display area 21 from the top in FIG. 11. As a result, since the value of the consecutive winning counter is “3” (S22: YES), the replay process (S23) is executed and as shown in the second symbol display area 21 from the top in FIG. 11, a message “Replay chance! Do you want to consume 10 coins and continue a consecutive winning?” is displayed on the display 120. At that time, the “YES” button and “NO” button are displayed on the display 120 (symbol display area 21). In addition, at this time, a value of “0/4” is displayed in the consecutive winning counter display area 211.

Thereafter, when the “NO” button is touched (S24: NO), the value of the consecutive winning counter is reset and returned to “0” (S26). In addition, at this time, as shown in the third symbol display area 21 from the top in FIG. 11, the value of “0/4” is consecutively displayed in the consecutive winning counter display area 211.

On the other hand, if the “YES” button is touched (S24: YES), “10” is subtracted from the value of the coin counter displayed in the game information display area 22 to display (S25). At this time, as shown in the fourth symbol display area 21 from the top in FIG. 11, a value of “3/4” is displayed in the consecutive winning counter display area 211. As a result, the value of the consecutive winning counter is displayed as restored to the value before resetting (“3/4”→“0/4”→“3/4”).

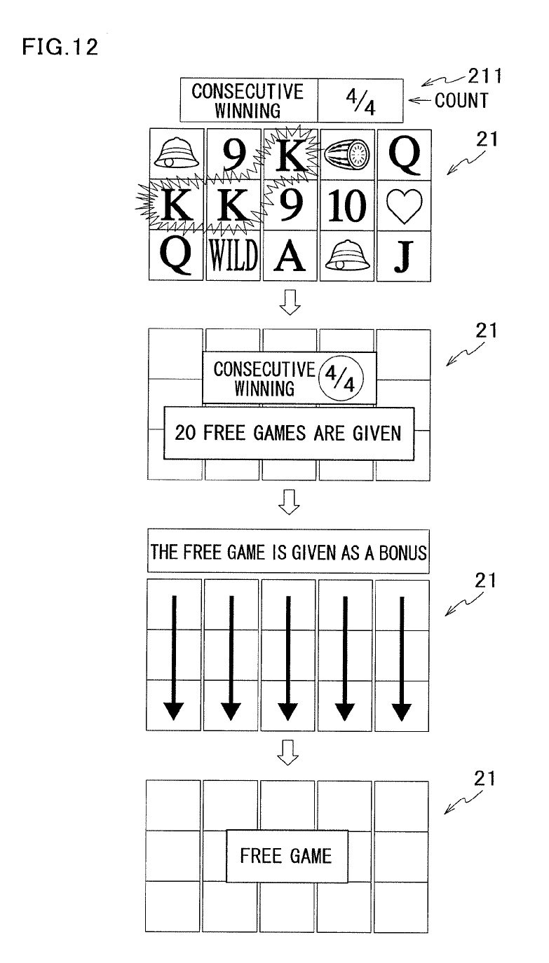

Thereafter, the process proceeds to the next slot game (goes to S11). Then, as a result of the symbol random determination process (S13) and the symbol display control process (S15) of the next slot game, it is assumed that a winning of 3 Kind of “K” is established as shown in the first symbol display area 21 from the top in FIG. 12. As a result, “1” is added to the value of the consecutive winning counter provided in the flash memory 104, and the value of “4/4” is displayed in the consecutive winning counter display area 211 of the display 120.

Then, since the value of the consecutive winning counter has reached “4” (S20: YES), as shown in the second symbol display area 21 from the top in FIG. 12, a message notifying that 20 free games are given is displayed on the display 120 (S21). As a result, the player can perform 20 slot games without consuming any coin.

(Bet Start Check Process)

Next, with reference to FIG. 9, the bet start check process will be described.

First, based on the information from the server 100, the CPU 101 determines whether or not there has been an exchange from a credit possessed by a player (a out-of-game currency that can be used outside the game) to a coin that can be used in the slot game (in-game currency) (S41).

If it is determined that the coin has been exchanged (S41: YES), the CPU 101 adds the number of exchanged coins to the value of the coin number counter provided in the flash memory 104 (S42).

After the process of S 42 or when it is determined that there is no exchange to coins in S41 (S 41: NO), the CPU 101 determines whether the value stored in the coin counter is “0” or not (S43). When it is determined that the value stored in the coin counter is “0” (S43: YES), the CPU 101 displays on the display 120 a message prompting the player to exchange coins from the credits possessed by the player, and highlights the image of the shop button 246 of the operation display area 24. Thereafter, the process proceeds to S41. In addition, when the image of the shop button 246 is touched, it is possible to access the server 100 from the smartphone 1 and move to the shop in which the credit can be exchanged for the coin.

On the other hand, when it is determined that the value stored in the coin counter is not “0” (S43: NO), the CPU 101 allows to accept the selection of the five stages of WAYS BET (WAYS BET 1, WAYS BET 2, WAYS BET 3, WAYS BET 4, WAYS BET 5) by pressing the touch panel 5 of the “+” button and the “−” button of the bet button 244 (see FIG. 1) (S44). The area as the object of the winning determination is determined from the 15 areas in 5 columns×3 rows of the symbol display area 21 by selecting five stages of the WAYS BET (see FIG. 4).

Next, the CPU 101 determines whether or not a selection operation (pressing) of five stages of WAYS BET (WAYS BET 1, WAYS BET 2, WAYS BET 3, WAYS BET 4, WAYS BET 5) is detected (S45). If the selection operation of WAYS BET is not detected (S45: NO), waiting for the selection operation.

On the other hand, when the selection operation of five stages of WAYS BET (WAYS BET 1, WAYS BET 2, WAYS BET 3, WAYS BET 4, WAYS BET 5) is detected (S45: YES), the CPU 101 adds the value of coins necessary for WAYS BET (1 coin if it is WAYS BET 1, 3 coins if WAYS BET 2, 7 coins if WAYS BET 3, 15 coins if WAYS BET 4, 25 coins if WAYS BET 5) to the value of the bet counter provided in the flash memory 104 (S46).

Next, after process of S46, the CPU 101 allow the acceptance of operation of the spin button 241 (S47).

After S47, the CPU 101 determines whether or not the operation of the spin button 241 is detected (S48). When the CPU 101 determines that the operation of the spin button 241 is not detected (S48: NO), waiting for the operation of the spin button 241.

On the other hand, when it is determined that the operation of the spin button 241 is detected (S48: YES), the CPU 101 subtracts the value of the bet counter calculated in S46 from the value of the coin counter (S49). Thereafter, the bet start check process is terminated.

According to the above embodiments, as a result of repeating a slot game, the number of times that the combination of symbols rearranged in the symbol display area consecutively wins is counted as a value of the consecutive winning counter. Then, when the value of the consecutive winning counter has reached “4”, 20 free games are given. However, when the combination of symbols rearranged in the symbol display area 21 does not win, since the value of the consecutive winning counter is reset, as a result of repeating the slot game, 20 free games will be given only when winning four consecutive times. However, even if no winning is established, when 10 coins are accepted (consumed), the resetting of the value of the consecutive winning counter can be canceled. Therefore, the player of the slot game can retry to acquire the 20 free games without resetting the value of the consecutive winning counter. As a result, even if a failure of no winning is encountered in a slot game, it is possible to cancel the failure by consuming 10 coins. As a result, it is possible to maintain the motivation for the player, and to eliminate the monotony of the slot game itself. In addition, since it is possible to retain the motivation of the player, there is also the effect that the possibility of inducing the consumption of coins increases.

### Other Embodiments

In the above embodiments, when the winning is established (S17: YES), as the first condition is satisfied, “1” is added to the value of the consecutive winning counter (S19). However, the first condition is not limited thereto, and a case where a specific winning may be established such as when 4 Kind of “A” is established, or conversely, a case where a winning may not be established is possible Likewise, in the above embodiments, the value of the consecutive winning counter is reset as a case where the second condition is satisfied when the winning is not established. However, the second condition is not limited thereto, and a case where a specific winning may be established such as when 3 Kind of “9” is established or a case where a winning is successively not established for a predetermined number of times.

Although the slot game has been described above as an example, the present invention is also applicable to other games. For example, it can be applied to a card game of blackjack. In this blackjack, two cards distributed from the shuffled cards' library are hand held cards and displayed on the display 120 (displayed in the symbol display area). Then, when the cards of the desired number are ready, a match is made by comparing with the opponent's card. As a result, when the player wins, a payout (30 coins) is given and “1” is added to the value of the consecutive winning counter. When failing, the value of the consecutive winning counter is reset. Then, when the value of the consecutive winning counter becomes “4” (4 consecutive winnings), 100 coins are given. In addition, when failing, the resetting of the value of the consecutive winning counter can be canceled by paying (consuming) 10 coins.

Although the embodiment of the present invention has been described above, it is merely a specific example, and the present invention is not particularly limited, and the specific configuration of each means and the like can be appropriately designed and changed. In addition, the effects described in the embodiments of the present invention are merely a list of the most preferable effects produced by the present invention, and the effects of the present invention are not limited to those described in the embodiments of the present invention.

What is claimed is:

1. An information processor comprising:
a display for displaying a game result obtained by a random determination,
a storage device, and
a controller programmed to execute:
(1a) a process of performing a random determination to display the game result determined by the random determination on the display,
(1b) a process of giving a first benefit when the game result obtained by the process of (1a) satisfies a first condition,
(1c) when the first condition is satisfied as a result of repeating the process of (1a) and the process of (1b), a value of a counter of the storage device is counted, and when a second condition is satisfied, a process of resetting the value of the counter of the storage device,
(1d) a process of giving a second benefit when the value of the counter reaches a predetermined value,
(1e) a process of allowing acceptance of a predetermined number of gaming mediums when the second condition is satisfied, and
(1f) a process of invalidating the resetting of the value of the counter of the storage device in the process of (1c) when there is the acceptance of the predetermined number of gaming mediums.

2. The information processor according to claim 1, wherein:
the controller,
in the process of (1e), allows the acceptance of the predetermined number of gaming mediums only when the second condition is satisfied and the value of the counter is one less than the predetermined value.

3. An information processor comprising:
a display for displaying a matrix-like symbol display area in which a plurality of symbols are rearrangeable,
a storage device, and
a controller programmed to execute:
(2a) a process of determining a combination of symbols to be rearranged in the symbol display area of the display by a random determination and rearranging the combination of the symbols determined by the random determination in the symbol display area of the display,
(2b) a process of giving a first benefit when the combination of the symbols obtained by the process of (2a) satisfies a first condition,
(2c) when the first condition is satisfied as a result of repeating the process of (2a) and the process of (2b), a value of a counter of the storage device is counted, and when a second condition is satisfied, a process of resetting the value of the counter of the storage device,
(2d) a process of giving a second benefit when the value of the counter reaches a predetermined value,
(2e) a process of allowing acceptance of a predetermined number of gaming mediums when the second condition is satisfied, and
(2f) a process of invalidating the resetting of the value of the counter of the storage device in the process of (2c) when there is the acceptance of the predetermined number of gaming mediums.

4. A game control method comprising the steps of:
(3a) performing a random determination to display a game result determined by the random determination on a display,
(3b) giving a first benefit when the game result obtained by the step of (3a) satisfies a first condition,
(3c) when the first condition is satisfied as a result of repeating the step of (3a) and the step of (3b), a value of a counter of a storage device is counted, and when a second condition is satisfied, resetting the value of the counter of the storage device,
(3d) giving a second benefit when the value of the counter reaches a predetermined value,
(3e) allowing reception of a predetermined number of gaming mediums when the second condition is satisfied, and
(3f) invalidating the resetting of the value of the counter of the storage device in the step of (3c) when there is the acceptance of the predetermined number of gaming mediums.

5. A non-temporary recording medium storing a game program executed by a computer of an information processor,
the game program controlling the computer to perform:
(4a) a process of performing a random determination to display a game result determined by the random determination on a display,
(4b) a process of giving a first benefit when the game result obtained by the process of (4a) satisfies a first condition,
(4c) when the first condition is satisfied as a result of repeating the process of (4a) and the process of (4b), a value of a counter of a storage device is counted, and when a second condition is satisfied, a process of resetting the value of the counter of the storage device,
(4d) a process of giving a second benefit when the value of the counter reaches a predetermined value,
(4e) a process of allowing acceptance of a predetermined number of gaming mediums when the second condition is satisfied, and
(4f) a process of invalidating the resetting of the value of the counter of the storage device in the process of (4c) when there is the acceptance of the predetermined number of gaming mediums.
